(19) United States
(12) Patent Application Publication
(10) Pub. No.: US 2008/0042485 A1
(43) Pub. Date: Feb. 21, 2008

(54) Balancing Weight for Vehicle Wheels, Comprising a Concavely or Convexly Curved Contact Face, and Method for the Production Thereof

(76) Inventor: Dietmar Wagenschein, Veitshochheim (DE)

Correspondence Address: Scott R Foster;Pandiscio & Pandiscio, 470 Totten Pond Road, Waltham, MA, 02451-1914, US

(21) Appl. No.: 10/553,079

(22) PCT Filed: Apr. 13, 2004
(86) PCT No.: PCT/EP04/50508

§ 371 Date: Oct. 15, 2007

(30) Foreign Application Priority Data
Apr. 11, 2003 (EP) 03100992.1

(51) Int. Cl. G01M 1/02; B21K 1/00

(52) U.S. Cl. 301/5.21; 29/894.38

(57) ABSTRACT

A balancing weight for vehicle wheels, the weight including a body provided with a concavely or convexly curved contact face for resting against a convexly or concavely curved rim part of a wheel, such as a rim flange. The contact face includes a plurality of successive lateral sections which are separated from each other by bends or edges of differently dimensioned curvatures.

The invention relates to a balancing weight for vehicle wheels, having a weight body, which has a concavely or convexly curved contact face for applying to a convexly or concavely curved portion of the rim of the wheel, in particular to a rim flange. The invention further relates to a method of manufacturing such a balancing weight.

Balancing weights are known composed of lead, which is relatively soft and can therefore be subjected to plastic deformation even retrospectively when being mounted on a wheel rim in order to achieve a positive contact with the rim flange of the vehicle wheel. For assembly of lead balancing weights, the differences between various types of rim (aluminium, steel rims) and rim designs of different vehicle manufacturers and the differences in the rim diameter (13 inches to 22 inches) are not important, since lead is a soft material and by its relatively easy plastic deformability can be adapted to the respective rim diameter or radius. Consequently, the manufacturers of balancing weights have only had to take the rim diameter into account for the geometry of the lead balancing weights to the extent that an average value is used as a basis for the same. In rims with a diameter other than the average value, retrospective adaptation of the shape of the lead balancing weight for the purpose of assembly on the vehicle wheel is possible. However, for several reasons, there is a considerable need to avoid or substitute lead as a material for balancing weights.

As substitute materials, recently steel and zinc have been used for balancing weights (cf. e.g. Offenlegungschrift DE 101 02 321 A1 by the Applicant). However, steel and zinc are much harder than lead, so they cannot be adapted retrospectively to different rim diameters by simple deformation or the like. In order to counter this problem, the obvious solution is simply to manufacture balancing weights up to a maximum length or weight and no longer to exceed this. The length or weight is so dimensioned in this obvious alternative (e.g. lengths of 60-70 mm or weights of up to approx. 40 g) that the corresponding weights can be mounted easily on all rims. In practice, however, imbalances of more than 40 g can occur (balancing weights of 60 g are currently standard), so that in this alternative two or more balancing weights would have to be assembled, which is time-consuming and expensive. Another easy alternative for overcoming the abovementioned problem is to manufacture balancing weights which are specially cut to length for the different diameters of most wheel rims commercially available, but then the storage and manufacturing costs are too high. Finally, in order to overcome the abovementioned problem, one could still consider manufacturing balancing weights which extend on the contact face (rim reverse face) allocated to the portion of rim on the basis of a reverse face radius of curvature, which is dimensioned as small as possible and still permits practicable use. Such a balancing weight could be mounted on all current rims. However, in the case of large rim diameters, there is the disadvantage that the balancing weight projects at its ends and due to a minimal contact area can be pushed away easily from the point of impact in the central region.

The object of the invention is to create a balancing weight which can be used without the need for plastic deformation in assembly for the maximum possible number of rim types with different diameters without the need for plastic deformation during assembly. For the latter, a balancing weight which is virtually universal is to be created. To achieve this, we refer to the balancing weight indicated in claim 1 and to the method of manufacture indicated in claim 20 of a corresponding balancing weight. Optional, advantageous embodiments of the invention will appear from the dependent claims.

With the invention, the way to substituting environmentally harmful lead by zinc or steel or other materials mentioned in the claims is simplified, because now it is no longer necessary to subject the balancing weight to retrospective plastic deformation in order to adapt to different rim diameters.

The manufacturability is simplified if according to an optional embodiment at least one lateral section, preferably plural or all, extend along circular curves or on the basis of constant radii of curvature. The manufacture of circular shapes is simple to carry out by means of machine tools.

According to an optional embodiment of the invention, it is sufficient if for the progressions of the side sections at least two differently dimensioned radii of curvature are used. For example, the contact face could be divided into three sections, the middle one of which extends along the largest radius of curvature whilst the two outer ones accordingly extend along a uniformly identical, smaller radius of curvature. In this case the two outer (end) lateral sections can be executed identically in pairs with respect to a hypothetical line of symmetry (penetrating the weight body transversely).

Included in the scope of the invention are radii of curvature for one or more or all lateral sections whose value extends towards infinity, i.e. the lateral section concerned is rectilinear. Rectilinear progressions of the lateral sections can be particularly advantageously within the central region of the contact face in order to be able to abut sufficiently against the rim portions of large diameter.

Conversely, for rims with a small diameter, an optional embodiment of the invention is advantageous in which two outer lateral sections or two lateral end sections are provided with the smallest of the occurring radius or radii of curvature. The lateral end sections with this curve then give the best positive fit with the rim area allocated, and on the other hand the gap in the central region between the contact face and the opposing rim face is kept within limits, so that it can be bridged without overload by an integral or integrally cast or subsequently mounted holding spring.

Particularly if the lateral sections consecutive to the contact face are so structured that radii of curvature which increase in value from the lateral end to the lateral centre, and radii of curvature which decrease in value form the lateral centre to the lateral end, a corresponding (universal) balancing weight can be used for almost all rim diameters without incurring assembly or service-life problems.

The notion of the invention is however not limited to circular progressions of the lateral sections (with constant curvature or constant radius of curvature) and/or to rectilinear/linear progressions. Thus the lateral sections of the contact face can be provided with curvatures which vary over the distance or with curvatures which extend in a parabolic, hyperbolic and/or elliptical manner.

Advantageously, the different radii of curvature for the individual lateral sections of the weight body contact face are so selected that outside the smallest and inside the largest radius or radii of curvature predominate. The size ratios between the individual radii of curvature are advantageously selected according to models given below, n representing the number of lateral sections. In this case two cases A and B are to be distinguished:

R1 is on the left-hand (or right-hand) end of the contact face and Rn to the right-hand (or left-hand) end of the contact face.

Case A: n [2 illegible symbols] 6, 8

130 mm<R1<330 mm.

R2>R1

R3>=R2

R4>=R3

R5>=R4

R(n/2)>=R(n/2−1)

R(n/2+1)<=R(n/2)

R(n/2+2)<=(R(n/2+1)

R(n−1)<=R(n−2)

Rn<R(n−1)

130 mm<Rn<330 mm

Case B: n=3, 5, 7, . . .

130 mm<R1<330 mm

R2>R1

R3>=R2

R4>=R3

R5>=R4

R((n+1)/2)>=R((n+1)/2−1)

R((n+1)2+1)<=R((n+1)/2)

R((n+1)2+2)<=R((n+1)2+1)

R(n−1)<=R(n−2)

Rn<R(n−1)

130 mm<Rn<330 mm

The upper limit Rn for the radius of curvature can in the case of heavy goods vehicles or other commercial vehicles extend up to 600 mm. On the other hand, even in the case of miniature wheel applications, lower limits for radii of curvature R1 of up to 100 to 120 mm are conceivable.

Further details, features, combinations of features, and advantageous effects on the basis of the invention will appear from the following description of preferred embodiments of the invention and from the drawings, which show:

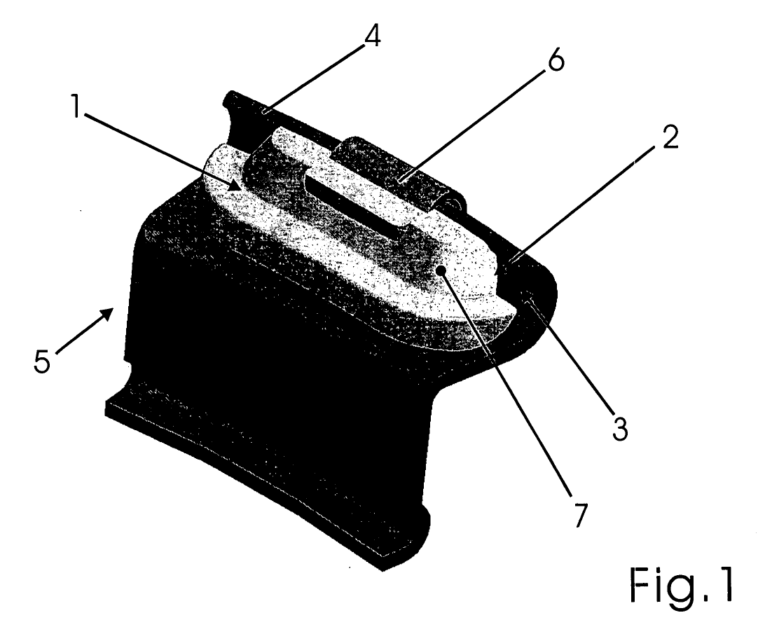

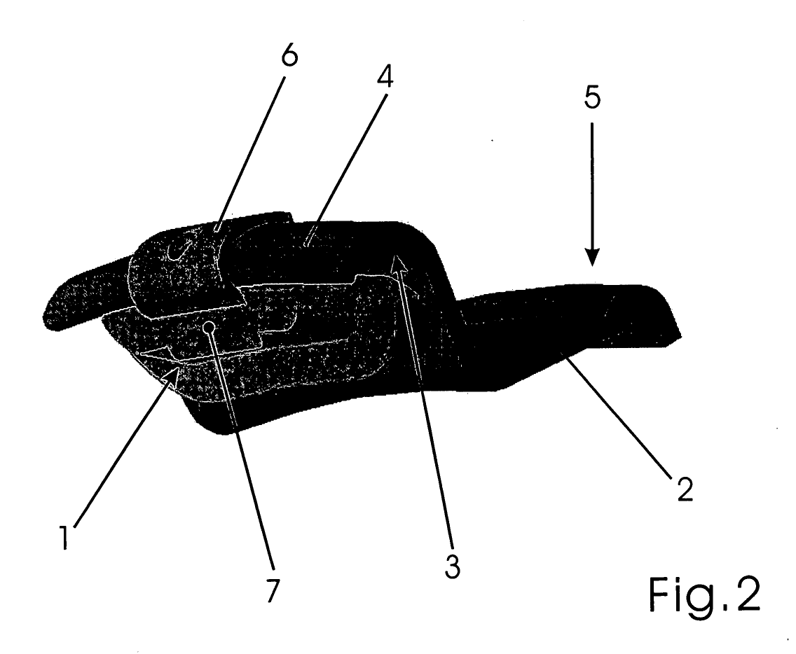

FIG. 1 and FIG. 2: in different perspective views an impact balancing weight fixed to a rim flange,

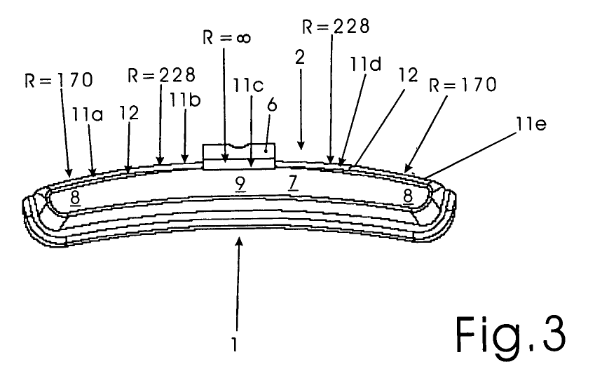

FIG. 3, a perspective view of a balancing weight according to the invention,

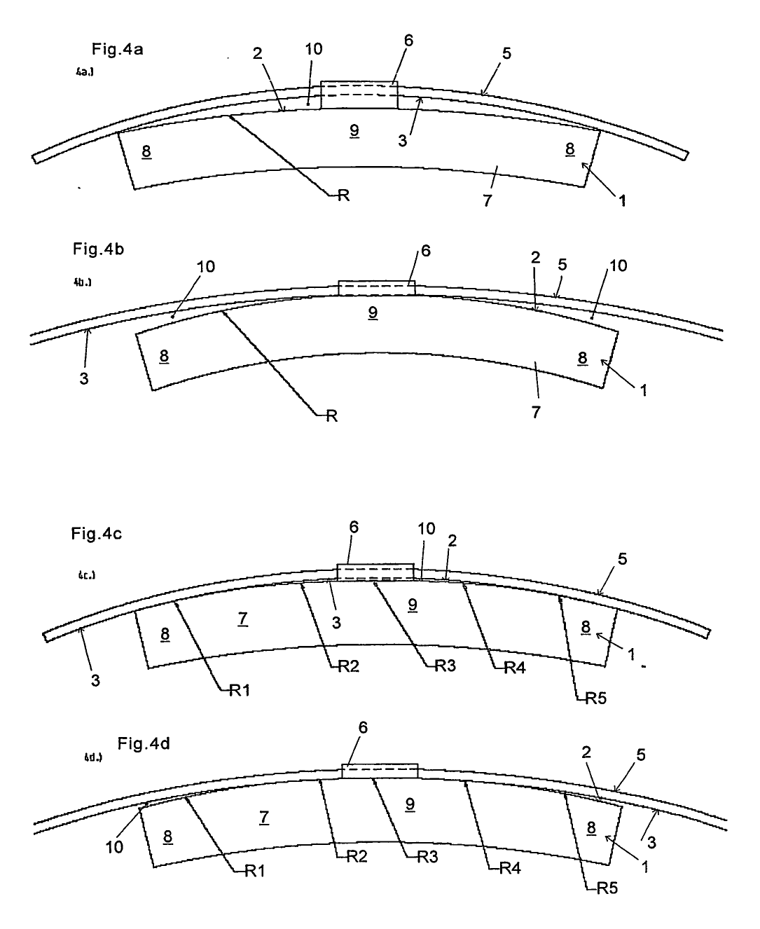

FIGS. 4a-4d, four end views of a wheel rim with impact balancing weight for illustrating the mode of operation of the invention with the aid of a comparison of the respective geometric fixing conditions of the conventional balancing weight (FIG. 4a, 4b) with those of the balancing weight according to the invention (4c, 4d), and

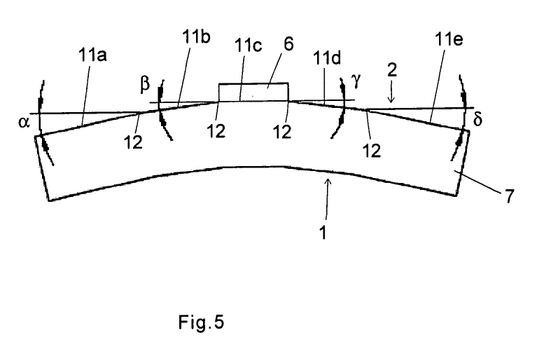

FIG. 5, in a diagrammatic representation a plan view of a further embodiment of the invention.

FIGS. 1 and 2 show an impact balancing weight 1 with its rear convex contact face 2 fixed to the concave inner face 3 of the flange 4 of a rim 5 (only shown in part) for vehicle wheels (passenger vehicle, heavy goods vehicle, bus, motor cycle). As fixing means, a holding and clip spring 6 e.g. of hardened spring steel is used, which is cast into the weight body 7 or is otherwise incorporated therewith. With a bent section, the clip spring 6 projects from a weight body 7 and encompasses the rim flange 4. The contour (geometry) of the balancing weight 1 with the clip spring 6 cast therein is set by the manufacturer. Since there are many types of rim, but a separate type of weight is not to be manufactured for each type of rim, (for reasons of storage, to minimise the number of variants, and for reasons of cost), for the balancing weight 1 a geometry is to be aimed at which permits assembly on as many types of rim as possible.

As a tool for assembling the impact balancing weight 1 on the car rim 5, the use of an assembly tool is known by means of which the balancing weight 1 is knocked on to the rim 5. In this case, the clip spring 6 is set on the rim flange 4 with its curved end projecting from the weight body 7, and is struck with the assembly tool until it snaps on.

After assembly, the balancing weight 1 should abut the rim flange 4 as immovably as possible. This is assisted by a convex curvature on the contact face 2 (reverse face) and the curvature should permit positive and/or non-positive connection to the opposing, concavely curved rim inner face 3. To this end, the contact of the balancing weight 1 on the rim inner face 3 must be effected over as large an area as possible in order to ensure the maximum possible holding and immovability on the assembly point (point determined by a balancing machine for compensating the imbalance). The non-positive connection between the rim 5 and the balancing weight 1 is produced via a clip spring 6, which is connected positively to the weight body 7 by means of integral casting and which clips the same by overlapping and grasping the rim flange 4 on the rim 5.

If the balancing weight 1 has a convex, reverse contact face 2 with a firmly specified radius of curvature, and the rim 5 likewise has a specified diameter (radius), then according to FIG. 4a a relatively long balancing weight 1 will rest on a rim 5 with a relatively small diameter (e.g. 13 inches) only with its end regions 8 on the rim 5 or on the rim flange. In this case there is a risk that (at first) the clip spring 6 cannot correctly engage around the rim or rim flange. To assist, the balancer must bend the weight body 7 in particular at its end regions 8, by hitting the weight body 7 in its central region 9 slightly with the assembly tool in order that the curvature of the balancing weight contact face 3, which is smaller compared to that of the concave rim inner face 3, changes accordingly and fits the inner curvature of the rim inner face 3. Then the clip spring 6 can be knocked over the rim 5 or its flange. This is not easily possible in the case of weight bodies manufactured from lead which are soft, without causing damage to the rim 5 or the weight body 7.

Conversely, according to FIG. 4b, in the case of relatively large rim diameters (e.g. 18-22 inches), resulting in a relatively small curvature due to the correspondingly large radius of curvature, the balancing weight 1 can be assembled relatively easily, due to the smaller radius of curvature R of the contact face 2. However, the end regions 8 stick up from the rim 5, creating a gap 10 between the two (similarly in FIG. 4a in the middle region 9). According to FIG. 4b, the contact face 2 consequently touches the rim 5 only in the middle region 9. This results in correspondingly reduced non-positive locking. Due to the projecting end regions 8, additionally the balancing weight 1 can be easily pushed off e.g. by cleaning brushes of a car-wash, because non-positive locking is only achieved in the middle region 9. As a remedy, provided the weight body 7 is manufactured from relatively soft lead, the end regions 8 can be knocked on to the rim inner face 3 with an assembly tool, which in the case of lead as a material is possible without damage to the rim and balancing weight due to its softness.

The cited bending or “knocking on” method is no longer possible however with any “hard” materials such as zinc and steel in particular, which are increasingly being used as lead-free alternatives for balancing bodies. As a remedy, according to FIG. 3, for all current rim diameters according to the invention a universal balancing weight 1 is created, whose contact face 2 is distinguished by a plurality, in the example shown by five, lateral sections 11a, 11b, 11c, 11d and 11e, which are joined together in a row via obtuse-angled bends 12 or other irregularities in the longitudinal direction of the weight body 7. The two outer lateral sections 11a, 11e extend respectively with the smallest radius of curvature R=170 mm, whilst the middle lateral section 11c extends in a straight line in the central region 9, i.e. has a radius of curvature R=∞. The intermediate lateral sections 11b, 11d, which lie respectively between the middle lateral section 11c and one of the two outer lateral sections 11a, 11b, are respectively provided with a radius of curvature R=228 mm. Therefore, the respective radius of curvature R increases by stages from one lateral section to the next from the outer end region 8 until the middle region 9, from which it decreases again in stages until the other end region 8.

According to FIG. 4c, in rims 5 with a relatively small diameter (possibly in the region of 13 inches), a balancing weight 1 which is relatively long or large and is 40-60 g heavy abuts with both end regions 8 the rim inner face 3. In the middle region 9, only a relatively small gap 10 remains between the rim inner face 3 and the contact face 3, so that a clip spring can be knocked on over the rim flange without risk of strain and damage. This is due to the structure according to the invention, according to which five lateral sections are defined by respectively different radii of curvature R1, R2, R3, R4, R5. In this case, similarly to FIG. 3, the radii of curvature increase in stages from the two end regions 8 to the central region 9. In other words, the contact face 2 of the balancing weight according to the invention is more strongly curved in the two end regions 8 than in the middle region 9.

In FIG. 4d, the situation for rims 1 with relatively large diameter (in the range of 20 inches) is shown. The rim inner face 3 has a smaller curvature or a larger radius of curvature than the largest radius of curvature R3 in the middle region 9 of the balancing weight 1 according to the invention. In its end regions 8, the contact face 2 is formed with even more strongly curved lateral sections, so that a relatively small gap 10 is formed between the rim inner face 3 and the lateral sections in the two end regions 8. Since in the middle region 9 the contact face 2 of the balancing weight 1 is formed with the least curved lateral section, i.e. with the largest radius of curvature R3, there the balancing weight 1 can abut the rim inner face over a relatively large length of e.g. about 50 mm. This produces correspondingly sufficient non-positive locking, which prevents slipping of the balancing weight 1.

Thus the advantage of the balancing weight 1 according to the invention can be seen, which can be mounted on all different sizes of rim.

The invention is not limited to embodiments with curved or rounded lateral sections of the contact face of the balancing weight. Thus according to FIG. 5, the contact face 2 can have five consecutive lateral sections 11a, 11b, 11c, 11d, 11e which all extend linearly or rectilinearly. Between these lateral sections, there are again bends 12. The lateral sections join one another via the bends 12 and at respective obtuse angles. The hypothetical extensions on each side of the central lateral section 11c include respective acute angles β, γ with the respectively adjacent intermediate lateral sections 11b, 11d. The hypothetical extensions of the two intermediate lateral sections 11b, 11d include the acute angles α and 8 respectively with the respectively adjacent end lateral sections 11a, 11e. This gives the relation:

β<αand γ<δ

This means, correspondingly to the radii of curvature R decreasing towards the end regions, in the embodiment according to FIG. 5 the angle of bending from the central region 9 to the end regions increases. This again produces the universal mountability of the balancing weight on all current rims.

### LIST OF REFERENCE NUMBERS

1 impact balancing weight

2 contact face

3 rim inner face

4 flange

5 wheel rim

6 clip spring

7 weight body

8 end region

9 middle region

10 gap

11a-11d lateral sections

12 bend

R, R1-R5 radii of curvature

α, β, δ, γ acute angles

1. Balancing weight (1) for vehicle wheels,the weight omprising a weight body (7) which has a curved contact face (2) for contact with a convexly or concavely curved rim portion (3, 5) of a wheel, in particular with a rim flange (4), and having a clamping element (6) which is a selected one of (1) structurally integral or (2) is provided subsequently with a holding spring, wherein the contact face (2) is divided into plural consecutive lateral sections (11a, 11b, 11c, 11d, 11e), which are defined from one another by bends (12), characterised and wherein at least three lateral sections (11a, 11b, 11c, 11d, 11e) are formed for contact with the rim portion and are joined together in a row via respective obtuse-angled bends (12).

2. Balancing weight according to claim 1, wherein the weight body (7) is of a mterial selected from the group consisting of zinc, steel, copper, brass, tungsten, gold, silver, or an alloy comprising one or said materials, and another material or alloy, harder than lead, including glass.

3. Balancing weight according to claim wherein at least one, of the lateral sections (11a, 11b, 11c, 11d, 11e) extends along a circular curve.

4. Balancing weight according to claim 1, wherein the curvatures of the plural lateral sections (11a, 11b 11c, 11d, 11e) are formed on the basis of at least two differently dimensioned radii of curvature (R1-R5)

5. Balancing weight according to claim 4, characterised in that a central one (11c) of the lateral sections (11a, 11b, 11c, 11d, 11e) extends on the basis of the largest (R3) of the radii of curvature (R1-R5).

6. Balancing weight according to claim 1, wherein at least one of the lateral sections (11a, 11b, 11c, 11d, 11e), extends a selected one of (1) rectilinearly or (2) on the basis of an infinitely long radius of curvature.

7. Balancing weight according to claim 1 wherein the contact face (2) is formed exclusively with the curved lateral sections (11a, 11b, 11c, 11d, 11e) on the basis of radii of curvature (R1-R5) which are smaller than infinite.

8. Balancing weight according to claim 1, wherein two outer lateral sections (11a, 11e) which form the two ends (8) of the contact face (2) are curved respectively on the basis of the smallest (R1, R5) of the radii of curvature (R1-R5).

9. Balancing weight according to claim 8, characterised by the use of at least three entirely or partially differently sized radii of curvature (R1-R5) for shaping the lateral sections (11a, 11b, 11c, 11d, 11e), the largest radius of curvature (R3) being allocated to a middle lateral section (11c), and the smallest radius of curvature being allocated to the two end lateral sections (11a, 11e) of the contact face (2).

10. Balancing weight according to claim 9, wherein the weight exhibits at least three differently sized radii of curvature (R1-R5) for shaping the lateral sections (11a, 11b, 11c, 11d, 11e), the radii of curvature (R2, R4) lying between the largest and smallest radius of curvature (R3, R1) in size being allocated to lateral sections (11b, 11d) which lie between the middle (11c) and the two end lateral sections (11a, 11e).

11. Balancing weight according to claim 1, wherein at least three of the lateral sections (11a, 11b, 11c, 11d, 11e) respectively following one another are provided with different radii of curvature (R1-R5).

12. Balancing weight according to claim 1 wherein the lateral sections (11a, 11b, 11c, 11d, 11e; FIG. 5) are a selected one of (1) exclusively rectilinear, and (2) extend on the basis of an infinitely long radius of curvature and form an open polygonal section.

13. Balancing weight according to claim 12, characterised in that hypothetical extensions of lateral sections (11a, 11b, 11c, 11d, 11e) form acute angles (α, β, δ, γ) with adjacent lateral sections (11a, 11b, 11c, 11d, 11e).

14. Balancing weight according to claim 13, wherein the acute angles (α, β, δ, γ) increase as the distance from the middle region (9) increases and are largest in the lateral sections (11a, 11e) in the end regions (8).

15. Balancing weight according to claim 1, characterised in that the curvatures of the individual lateral sections (11a, 11b, 11c, 11d, 11e) are at least one of not constant, correspond to the progression of a parabola, a hyperbola and an ellipse.

16. Balancing weight according to claim 1, wherein identically formed lateral sections (11a, 11e; 11b, 11d) are formed in pairs with respect to a hypothetical line of symmetry.

17. Balancing weight according to claim1, wherein that the clamping element (6) is cast of spring steel.

18. Balancing weight according to claim 1, wherein that the bends (12) have different distances from one another.

19. Method of manufacturing a balancing weight (1) for vehicle wheels, having a weight body (7) which has a contact face (2) for contact with a convexly or concavely curved rim portion (3, 5) of the wheel, in particular with a rim flange (4), wherein the contact face (2) is divided into plural consecutive lateral sections (11a, 11b, 11c, 11d 11e) which are defined with respect to one another by bends (12), and wherein the contact face is formed with a number n =3, 4, 5, . . . of consecutive lateral sections (11a, 11b, 11c, 11d, 11e) which follow one another respectively with different radii of curvature (R1-R5).

20. Method of manufacturing according to claim 19, characterised in that the associated radii of curvature R1, R2, . . . Rn are each constant and are dimensioned according to the following rules:
a) the first radius of curvature R1 is to the left-hand (or right-hand) end of the contact face and the last radius of curvature Rn is to the right-hand (or left-hand) end of the contact face;
b) u<R1, Rn<o, wherein u is a lower and o and upper measure for the radius of curvature;
c) with the following case distinction:
Case A: n is an even number and is at least 4: o=4, 6, 8, . . . etc.
u<R1<o
R2>R1
R3>=R2
R4>=R3
R5>=R4
R(n/2)>=R(n/2−1)
R(n/2+1)<=R(n/2)
R(n/2+2)<=(R(n/2+1)
R(n−1)<=R(n−2)
Rn<R(n−1)
u<Rn<o
Case B: n is an odd number and is at least 3: n=3, 5, 7, . . . etc.
u<R1<o
R2>R1
R3>=R2
R4>=R3
R5>=R4
R((n+1)/2)>=R((n+1)/2−1)
R((n+1)2+1)<=R((n+1)/2)
R((n+1)2+2)<=R((n+1)2+1)
R(n−1)<=R(n−2)
Rn<R(n−1)
u<Rn<o

21. Method of manufacture according to claim 20, characterised in that the radius of curvature is at least u=120 mm and at most o=600 mm.

22. Method of manufacture according to claim 20, wherein radii of curvature (R1-R5), preferably one allocated to a middle lateral section (11c), is dimensioned with an amount going towards infinity.

23. Method of manufacture according to claim 20, wherein at least a middle one of the lateral sections (11a, 11b, 11c, 11d, 11e), is dimensioned with a length of about 40 mm to 60 mm.
